(19) United States
(12) Patent Application Publication
(10) Pub. No.: US 2011/0029559 A1
(43) Pub. Date: Feb. 3, 2011

(54) METHOD, APPARATUS, AND PROGRAM FOR EXTRACTING RELATIVITY OF WEB PAGES

(75) Inventors: Katsuro KIKUCHI, Musashino (JP); Keisuke Matsubara, Yokohama (JP); Katsushi Yako, Yokohama (JP); Ken Naono, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/711,708

(22) Filed: Feb. 24, 2010

(30) Foreign Application Priority Data
Aug. 3, 2009 (JP) 2009-187035

(51) Int. Cl. G06F 17/30

(52) U.S. Cl. 707/770; 707/772; 707/E17.014; 707/E17.032

(57) ABSTRACT

Even when the operation of web page referencing or search is discontinuous and implicit, relativity between web pages is extracted. A web relativity extraction unit is executed as a program by the processing unit of a recommendation server. The web relativity extraction unit extracts relativity between web pages about a search term related to the web pages. Further, it considers a user's information search model based on the process of accessing between web pages and quantitatively evaluates a relativity degree indicating the intensity of relativity and thereby extracts relativity between the web pages.

### CLAIM OF PRIORITY

The present application claims priority from Japanese patent application JP 2009-180735 filed on Aug. 3, 2009, the content of which is hereby incorporated by reference into this application.

### FIELD OF THE INVENTION

The present invention relates to a technology for extracting the implicit relativity between web pages referred to in an operation of referring to one or more web pages and investigating some case, recommending a web page based on the extracted relativity, and providing navigation information for referring to the web page.

### BACKGROUND OF THE INVENTION

In recent years, it has become increasingly easier to acquire a wide variety of information through the web (World Wide web). Since a vast quantity of information is shown to the public on the web, meanwhile, it has become difficult to efficiently arrive at relative information.

It is important also for business organizations to efficiently arrive at relative information. Technical support centers and help desk operations conduct investigation and make replies based on multiple pieces of reference information with respect to the contents of inquiries from customers. It is important for them to efficiently find reference information pertaining to the contents of inquiries. To meet such needs, systems have been provided for recommending information pertaining to a web page when the web page is referred to and helping users to quickly arrive at relative information.

There are, for example, the following conventional technologies: a technology in which the input of a search term and the transition of web pages are captured and based on web page-to-web page transition information, a web page to be referred to next is recommended to a user who underwent the similar page transition (for example, JP-A-2007-102767); a technology in which a database holding sets of search purposes and search terms to be recommended is prepared beforehand, a search purpose is estimated from a user's search term, a search term to be recommended is acquired from the database, and the search term is recommended (for example, JP-A-2009-003515); and a technology for assisting in assembling and organizing information (for example, JP-A-2008-225936).

### SUMMARY OF THE INVENTION

In the conventional technology described in JP-A-2007-102767, histories of web page referencing and web page search are recorded by a UI (User Interface) unit capable of displaying and searching for web pages. When a link to another web page contained in a web page is clicked, the UI unit records the transition of web pages. The UI unit makes it possible to select a specific keyword in a web page and search for a web page by the selected keyword. The UI unit displays a list of search results. When the user selects a web page from the list and causes it to be displayed, the UI unit can capture by what search term transition was caused, together with information on transition between web pages. With this conventional technology, another web page is referred to by clicking a link in a web page and a web page is searched for a keyword and a web page related to the keyword is referred to. When the transition and search of web pages are continuously and explicitly carried out as mentioned above, it is possible to grasp the relation between web pages with the conventional technology.

In information search, however, a process of trial and error is often repeated. Consideration will be given to a complex and uncertain inquiry, for example, “Is there a method to register an IME dictionary for PCs in a domain by batch processing?” to a technical support center. In this case, the following steps are taken: a search is performed with a keyword pertaining to the contents of the inquiry, several web pages are referred to based on the obtained search result to identify a useful-looking web page or information in the web page (Step 1); and the identified web page and the information in the web page are compared with the contents of the inquiry and investigation is conducted in still greater depth with respect to the following (Step 2): web pages seeming to be more deeply pertinent, to the contents of the inquiry and information in the web pages. As mentioned above, two operations are often repeated. At Step 1, wide and shallow searching is carried out and at Step 2, narrow and deep searching is carried out. At Step 1, pieces of information that will be candidates in the deeper research at Step 2 are recorded in a hand-written note or the user's own memory. At Step 2, search operation is newly started with respect to information that more seems to be the favorite among the recorded pieces of information.

When such trial-and-error information search as mentioned above is conducted, the operation of the web browser is discontinuous and implicit between Step 1 and Step 2. Therefore, the conventional technology cannot capture the relativity between web pages.

In the conventional technology described in JP-A-2009-003515, it is required to register a search purpose and a search term to be recommended. The conventional technology described in JP-A-2008-225936 is used to help a user to assemble and organize information (knowledge). However, it is required to manually determine the hierarchical relation (the degree of abstraction and the like) of information groups. Therefore, the conventional technology is effective in a specific environment but in general it poses a problem of cost.

When recommendation or organization advanced to some degree is carried out as in these conventional technologies, time and effort is produced in managing captured information. For operation in which the time and effort is smaller than the outcome, these technologies are effective. However, it is difficult to apply the technologies to operation in which the time and effort is larger.

The invention has been made in consideration of the two above-mentioned problems. It is an object of the invention to provide a system that helps a user who performs operation by information search to promote the efficiency of the information search. The system helps the user by extracting the relativity between web pages and recommending a web page or carries out other like processing based on the extracted relativity even in discontinuous and implicit web page referencing. Manual maintenance work is excluded from the above operation; therefore, the system is applicable to various operations.

The two information search steps mentioned above are characterized in that at Step 2, a deeper investigation is conducted into information preliminarily investigated at Step 1. Therefore, when a search term pertaining to a first web page referred to at Step 2 is contained in a second web page at Step 1, this can be considered as follows: information (search term) in the second web page is investigated in detail in the first web page.

In the invention, consequently, the relativity between web pages is extracted by taking the following measure: based on the features of the above information search, the relativity between web pages is extracted about a search term; based on the process of accessing between web pages, the user's information search model is considered; and a relativity degree indicating the intensity of relativity is quantitatively evaluated.

More specifically, the relativity is extracted by the following unit: a unit for capturing the range between the start and the end (the range of a case) of an investigation matter of a worker of investigation; a unit for recording a search term for a web search server and the process of accessing web pages; a unit for detecting whether or not a first web page referred to within the range of the investigation matter is a web page to which transition was made from a search result of the web search server and the search term is contained in a second web page referred to within the range of the case; and a unit for, when the search term is contained, assuming that there is relativity between the web pages and quantitatively evaluating a relativity degree indicating the intensity of relativity between web pages based on the process of accessing between the first web page and the second web page.

That is, to achieve the above object, the invention provides a method, a device, and a program for extracting web page relativity. The extraction method for the relativity between web pages is carried out by a processing unit that extracts the relativity between web pages when one or more web pages are referred, to with respect to a case and the case is investigated. This processing unit executes the following procedures: a procedure for capturing the range of a case or the range between the start and the end of an investigation matter; a procedure for recording a search term for a web search server and the process of accessing web pages; a procedure for detecting whether or not a first web page referred to within the range of the case is a page to which transition was made from a search result of the web search server and the search term is contained in a second web page referred to within the range of the case; and a relativity extraction procedure for, when the search term is contained in the second web page, assuming that there is relativity between the first and second web pages and evaluating a relativity degree indicating the intensity of the relativity between the first and second web pages based on the process of accessing between the first and second web pages.

According to the invention, it is possible to provide a more practical recommendation by finding the relativity between web pages even in cases where web page transition is discontinuous and implicit and it is conventionally difficult to find the relativity. The efficiency of information search can be improved by accurately providing pertinent information. Further, the utilization and sharing of resources present in house can be achieved by assembling and organizing information based on the relativity. Further, since web page relativity is extracted based on a user's routine operation, necessity for manual maintenance work is obviated.

### BRIEF DESCRIPTION OF THE DRAWINGS

FIG. 1 is a block diagram illustrating an example of the configuration of a computer system in a first embodiment;

FIG. 2 is a block diagram illustrating an example of the functional configuration of a recommendation server in the first embodiment;

FIG. 3 is an explanatory drawing of an example of an operation assumed in the first embodiment;

FIG. 4 is a flowchart illustrating an example of processing by the web proxy unit of a recommendation server in the first embodiment;

FIG. 5 is a composition diagram illustrating an example of a matter session management table provided in a recommendation server in the first embodiment;

FIG. 6 is a flowchart illustrating an example of processing by the matter session management unit of a recommendation server in the first embodiment;

FIG. 7 is an explanatory drawing illustrating an example of the input page of the matter management screen of a recommendation server in the first embodiment;

FIG. 8 is an explanatory drawing illustrating an example of matter information displayed at the time of a web page search in the first embodiment;

FIG. 9 is an explanatory drawing illustrating an example of recommendation information and matter information displayed at the time of web page referencing in the first embodiment;

FIG. 10 is a flowchart illustrating an example of processing by the web access recording unit of a recommendation server in the first embodiment;

FIG. 11 is a composition diagram illustrating an example of a search engine definition table provided in a recommendation server in the first embodiment;

FIG. 12 is a sequence diagram illustrating an example of a series of processes of web search and web page referencing in some matter investigation in the first embodiment;

FIG. 13 is a composition diagram illustrating an example of an access history management table provided in a recommendation server in the first embodiment;

FIG. 14 is a flowchart illustrating an example of processing by the useful web page capture module of a recommendation server in the first embodiment;

FIG. 15 is a flowchart illustrating an example of processing by the useful web page factor calculating unit of a recommendation server in the first embodiment;

FIG. 16 is a flowchart illustrating an example of processing of generating information on the process of accessing web pages by the web page relativity extracting unit of a recommendation server in the first embodiment;

FIG. 17 is a composition diagram illustrating an example of an access process management table provided in a recommendation server in the first embodiment;

FIG. 18 is a flowchart illustrating an example of relativity extraction processing by the web page relativity extracting unit of a recommendation server in the first embodiment;

FIG. 19 is a flowchart illustrating in detail an example of relativity degree calculation processing in relativity extraction processing by the web page relativity extracting unit of a recommendation server in the first embodiment;

FIG. 20 is an explanatory drawing illustrating an example of each evaluation element and relativity degrees in relativity degree calculation in relativity extraction processing by the web page relativity extracting unit of a recommendation server in the first embodiment;

FIG. 21 is an explanatory drawing illustrating an example of variations of components of evaluation in relativity degree calculation in relativity extraction processing by the web page relativity extracting unit of a recommendation server in the first embodiment;

FIG. 22 is a composition diagram illustrating an example of a web page relativity table provided in a recommendation server in the first embodiment;

FIG. 23 is an explanatory drawing illustrating an example of an input page of the relativity degree adjusting unit of a recommendation server in the first embodiment;

FIG. 24 is a flowchart illustrating an example of processing by the web page recommendation unit of a recommendation server in the first embodiment;

FIG. 25 is an explanatory drawing illustrating an example of recommendation information generated by a recommendation server in the first embodiment;

FIG. 26 is a block diagram illustrating an example of the functional configuration of an arrange and systematize information server in a second embodiment;

FIG. 27 is an explanatory drawing illustrating an example of a case where web page relativity is represented in the form of effective graph in the second embodiment;

FIG. 28 is a flowchart illustrating an example of processing by the navigation information generate unit of an arrange and systematize information server in the second embodiment; and

FIG. 29 is an explanatory drawing illustrating an example of content navigation information generated by an arrange and systematize information server in the second embodiment.

### DETAILED DESCRIPTION OF THE PREFERRED EMBODIMENTS

Hereafter, description will be given to embodiments of the invention with reference to the drawings. In this specification, it is kindly requested to note that each program executed by the processing unit of a computer system may be designated as “unit,” “unit,” “procedure,” “function,” or the like.

### First Embodiment

The first embodiment is obtained by applying the present recommend system to information search operation at a technical support center.

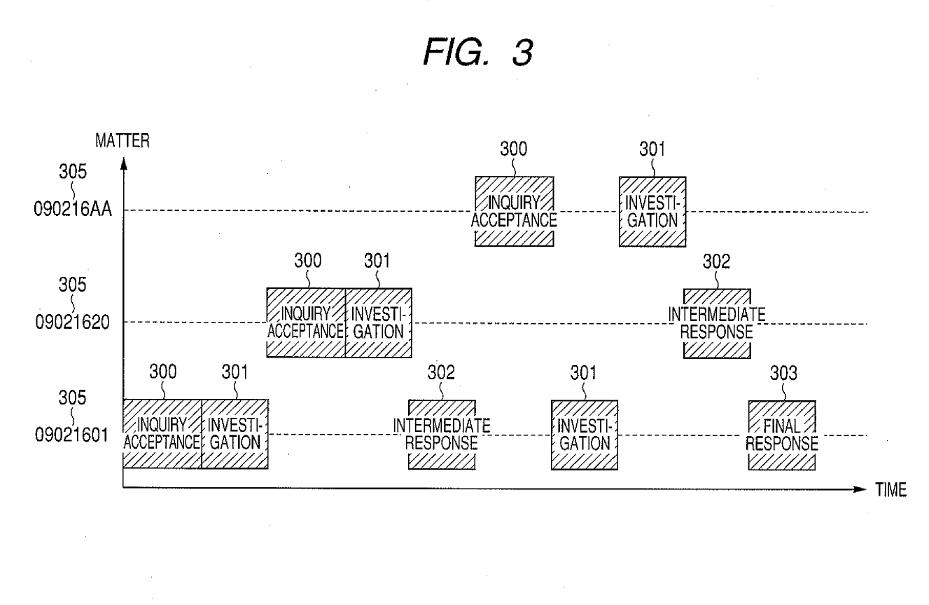

First, rough description will be given to the flow of support operation at the technical support center with reference to FIG. 3. At the technical support center, an inquiry from a customer is accepted (inquiry acceptance 300) and investigation 301 is conducted with respect to the contents of the inquiry. At the same time, an intermediate response 302 is periodically made to the customer and at last a final response 303 is made to the customer in response to the inquiry. This series of processes is managed by the unit designated as matter 305 and each worker simultaneously copes with multiple matters. In the work of investigation 301, each worker searches and refers to a knowledge database shown to the public on the web by a product vendor or case examples accumulated at the technical support center. The invention is intended to enhance the efficiency of the investigation work in this investigation 301.

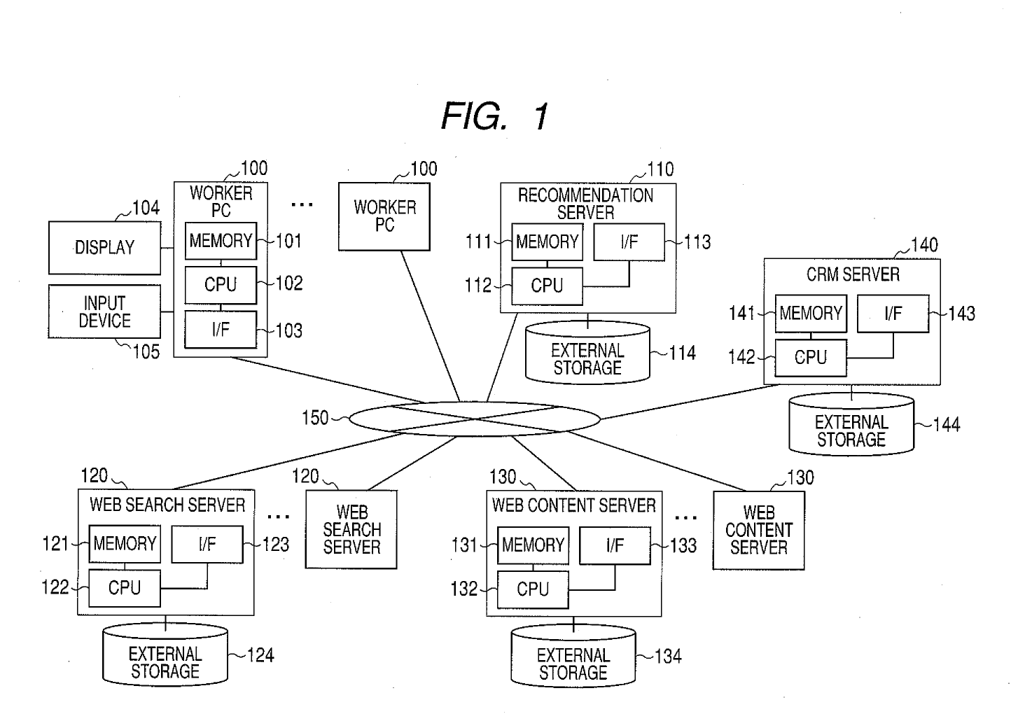

Hereafter, description will be given to this embodiment with reference to FIG. 1 to FIG. 25.

### <<Overall Configuration>>

FIG. 1 illustrates the overall configuration of a recommend system in this embodiment. This system includes: one or more worker PCs (Personal Computers) 100; one or more web search servers 120; one or more web content servers 130; a CRM (Customer Relationship Management) system 140; a recommendation server 110; and a network 150 that connects the above computer systems together.

The worker PC 100 is operated by a worker at the technical support center and is utilized in information investigation using a web search server 120 or a web content server 130. The worker PC 100 includes CPU (Central Processing Unit) 102 as a processing unit, a memory 101 as a storage unit, an interface (I/F) 103, a display 104, and an input device 105. The CPU 102 executes programs stored in the memory 101 connected through an internal bus or the like. The memory 101 temporarily stores programs executed by the CPU 102 and necessary data. The programs are specifically an operating system (OS), a web browser, and the like. The interface 103 connected to the CPU 102 through an internal bus or the like carries out data input/output between it and an external device, such as the display 104, input device 105, or network 150. The display 104 displays information calculated by the CPU 102. The input device 105 accepts input from a worker through a keyboard, a mouse, or the like. The worker PC 100 may additionally include an external storage and the like though not shown in the drawing.

The web content server 130 puts out information (hereafter, referred to as “web page”) to the worker PC 100 or the web search server 120. Similarly with the worker PC 100, the web content server 130 is comprised of CPU 132, a memory 131, an interface 133, an external storage 134, and the like. The external storage 134 holds web pages to be shown to the public. Each web page is described with a language, such as HTML (Hyper Text Markup Language) language, that can be interpreted by web client programs running on the worker PC 100 or the web search server 120. As an identifier for identifying each web page, URL (Uniform Resource Locator) is linked thereto.

The web content server 130 receives an HTTP (Hyper Text Transfer Protocol) request containing URL from a web client program. The web content server 130 acquires a web page related to this URL from the external storage 134 and sends it as an HTTP response to the web client program. The transmission and reception of web pages are carried out through the network 150 using such a communication protocol as HTTP. In addition to provision of static web pages stored in the external storage 124, the web content server 130 may dynamically generate a web page and provide it using a web application server, a CGI (Common, Gateway Interface) system, a database system, or the like.

The web search server 120 provides search service for web pages shown to the public by the web content servers 130. Similarly with the worker PC 100, the web search server is comprised of CPU 122, a memory 121, an interface 123, an external storage 124, and the like. The web search server 120 periodically acquires web pages shown to the public by the web content servers 130 connected to the network 150 by a web client program designated as Crawler and builds a database for searching. The web search server 120 accepts a search request from an worker PC 100 and sends a list containing the URL of a web page corresponding to the search request in response.

The CRM server 140 manages matters related to inquiries from customers. Similarly with the worker PC 100, the CRM server is comprised of CPU 142, a memory 141, an interface 143, an external storage 144, and the like.

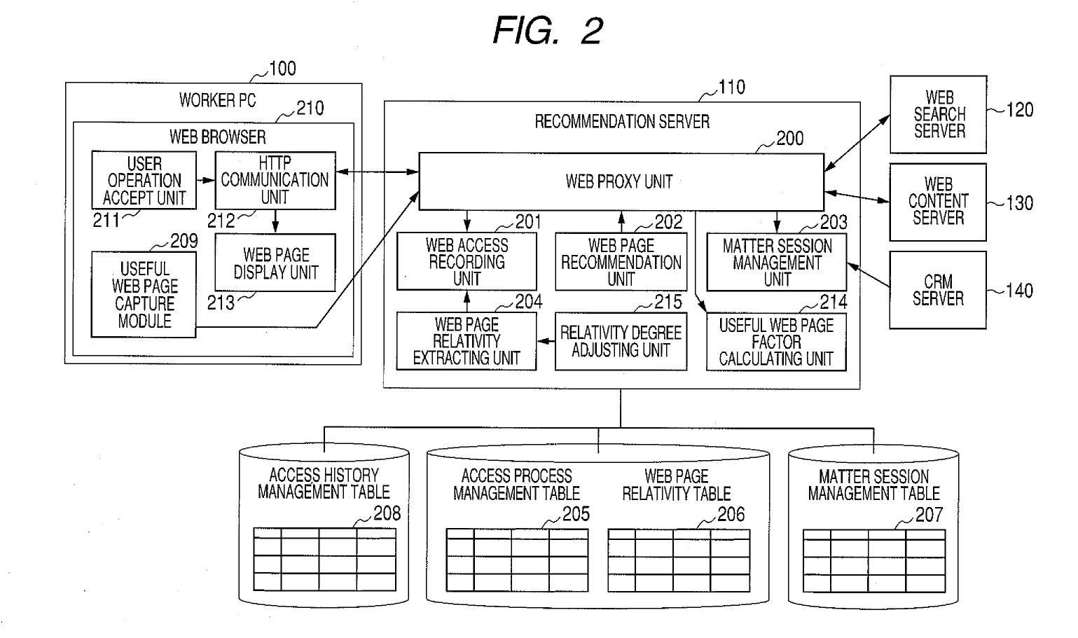

The recommendation server 110, provided in this embodiment, extracts relativity and recommends information. Similarly with the worker PC 100, the recommendation server is a computer system comprised of CPU 112, a memory 111, an interface 113, an external storage 114, and the like. Detailed description will be given to programs that run on the recommendation server with reference, to FIG. 2 to FIG. 25.

The network 150 connects the above computer systems together. The network 150 is provided by LAN (Local Area Network) in a business organization, WAN (Wide Area Network) connecting LANs together, or ISP (Internet Service Provider).

### <<Overview of Recommend System>>

FIG. 2 is a block diagram illustrating the functional elements of programs that run on the processing unit, or CPU, in the worker PC 100 and the recommendation server 110 related to the features of this embodiment in the overall system illustrated in FIG. 1. Description will be given to the overview of processing in this embodiment with reference to FIG. 2.

On the CPU 102 of the worker PC 100, a web browser 210 runs as a web client program. This and other programs are stored in a storage unit, such as the memory 101. Information search by a worker is conducted using this web browser 210. The web browser 210 is comprised of a user operation accept unit 211, an HTTP communication unit 212, a web page display unit 213, and in addition, a useful web page capture module and the like. The operation acceptance unit 211 accepts input of URL from a worker and requests the HTTP communication unit 212 to acquire a web page. The HTTP communication unit 212 analyzes the URL and sends an HTTP request to a web search server 120 or a web content server 130. When the HTTP communication unit 212 receives an HTTP response containing a web page, it requests the web page display unit 213 to display the web page. The web page display unit 213 analyzes the web page and displays it in a display area of the web browser. The above description shows an example of the program configuration of the web browser 210; however, the program may be configured in any way as long as it can operate as a web client.

A program executed on the CPU 112 of the recommendation server 110 is comprised of: a web proxy unit 200, a web access recording unit 201, a web page recommendation unit 202, a matter session management unit 203, a web page relativity extracting unit 204, a relativity degree adjusting unit 215, and a useful web page factor calculating unit 214. These units are stored in a storage unit such as the memory 111 and the external storage 114. In a storage unit such as the memory 111 and the external storage 114, an access process management table 205, a web page relativity table 206, a matter session management table 207, and an access history management table 208 are formed.

Similarly with ordinary proxy servers, the web proxy unit 200 mediates HTTP communication between a web browser 210 and a web search server 120 or a web content server 130 and further calls up various functions in the recommendation server 110. The web access recording unit 201 is called by the web proxy unit 200 during mediation of HTTP communication and records the history of web search and web page referencing by the web browser 210. The matter session management unit 203 grasps to which matter related to an inquiry the investigation work by web search or web page referencing by a worker corresponds. The useful web page capture module 209 runs on the web browser 210 on the worker PC 100 of a worker or the OS (Operating System) on an worker PC 100 not shown and captures the status of web page referencing utilizing the web browser 210.

The useful web page factor calculating unit 214 computes the serviceability of a web page based on the status of referencing the web page captured by the useful web page capture module 209. The web page relativity extracting unit 204 extracts the relativity between web pages about a search term that hit a web page referred to based on the history of web search or web page referencing recorded by the web access recording unit 201. To extract relativity, a relativity degree is quantitatively evaluated based on various elements in the process of referencing between web pages. The relativity degree adjusting unit 215 adjusts the weight of each element used in relativity degree evaluation at the web page relativity extracting unit 204. Since weighting differs from operation to operation, the above weight can be tuned in accordance with each operation. The web page recommendation unit 202 generates recommendation information on a web page based on the web page relativity extracted by the web page relativity extracting unit 204 and adds the recommendation information to the web page.

In this embodiment, the recommendation server 110, web search server 120, and web content server 130 are respectively provided as different devices. Instead, the web search server 120 may also function as the recommendation server 110. The recommendation server 110 may be installed as an application in the worker PC 100. Or, it may operate as add-on software to the web browser 210. Though the recommendation server 110 operates as a proxy, it may be configured as a reverse proxy search portal service and wrap screens of an external web system.

Detailed description will be given to each unit as programs of the recommendation server 110.

### <<Web Proxy Unit>>

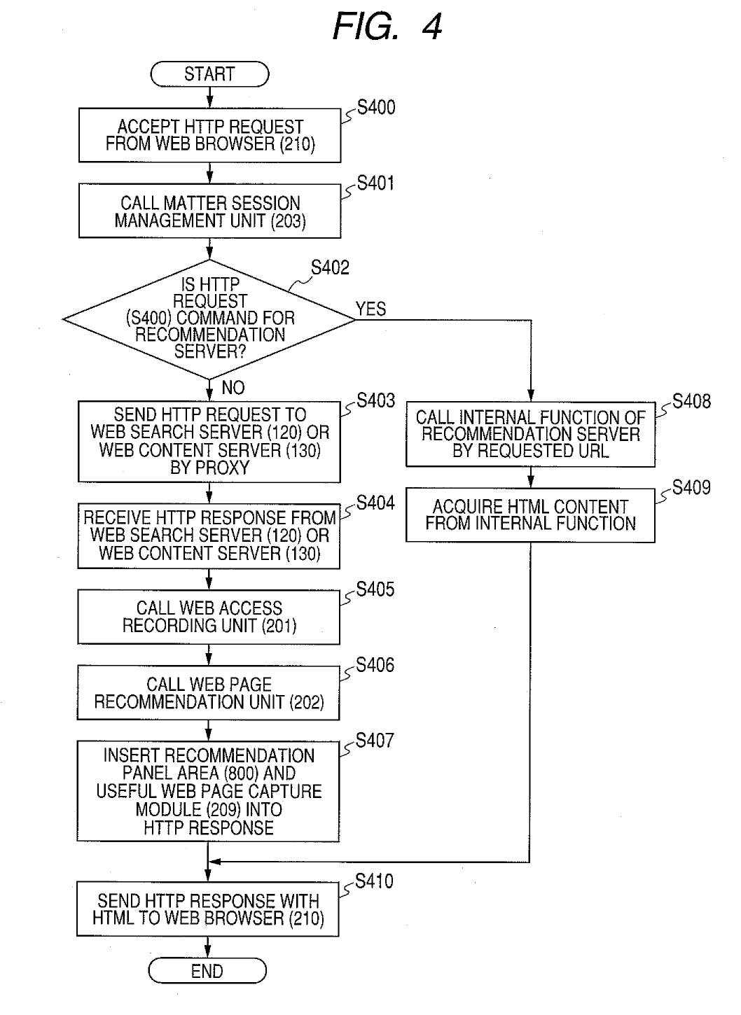

The web proxy unit 200 mediates HTTP communication between a web browser 210 and a web search server 120 or a web content server 130 and calls up a function in the recommendation server as required. FIG. 4 is a flowchart illustrating processing by the web proxy unit 200.

The web proxy unit 200 accepts an HTTP request from a web browser (S400). Subsequently, it calls the matter session management unit 203 (S401). Then it refers to URL in the received request and determines whether or not the HTTP request is a request to a function in the recommendation server (S402). When the HTTP request is a request to a function in the recommendation server, the web proxy unit refers to the URL in the HTTP request and calls up the corresponding internal function (S408). Subsequently, it acquires the result of processing by the called internal function in HTML (S409). Thereafter, the flow proceeds to Step 410.

When the HTTP request is a request to a web search server or a web content server (No at S402), the web proxy unit sends the HTTP request to the web search server or the web content server by proxy (S403). Then it receives an HTTP response from the server to which the HTTP request was sent (S404). It calls the web access recording unit 201 (S405). Subsequently, it calls the web page recommendation unit 202 (S406). Then it adds the HTML segment of a recommend panel 800 for indicating recommendation information and the like and the useful web page capture module 209 to the HTML in the HTTP response (S407). Finally, it sends the HTTP response to the web browser 210 (S410).

### <<Matter Session Management Unit>>

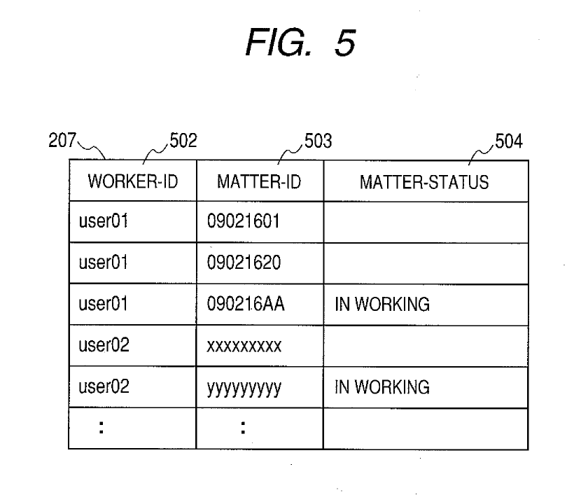

The matter session management unit 203 captures to which matter related to an inquiry the investigation work by web search or web page referencing using the web browser 210 corresponds. FIG. 5 illustrates the composition of the matter session management table 207 that holds matter management information. The matter session management table 207 is composed of: worker-id 502 for identifying a worker of a matter; matter-id 503 for identifying the matter; and matter status 504 for identifying which matter the worker is investigating. As illustrated in FIG. 5, each worker has charge of multiple matters but he/she is addressing any one matter at an arbitrary time.

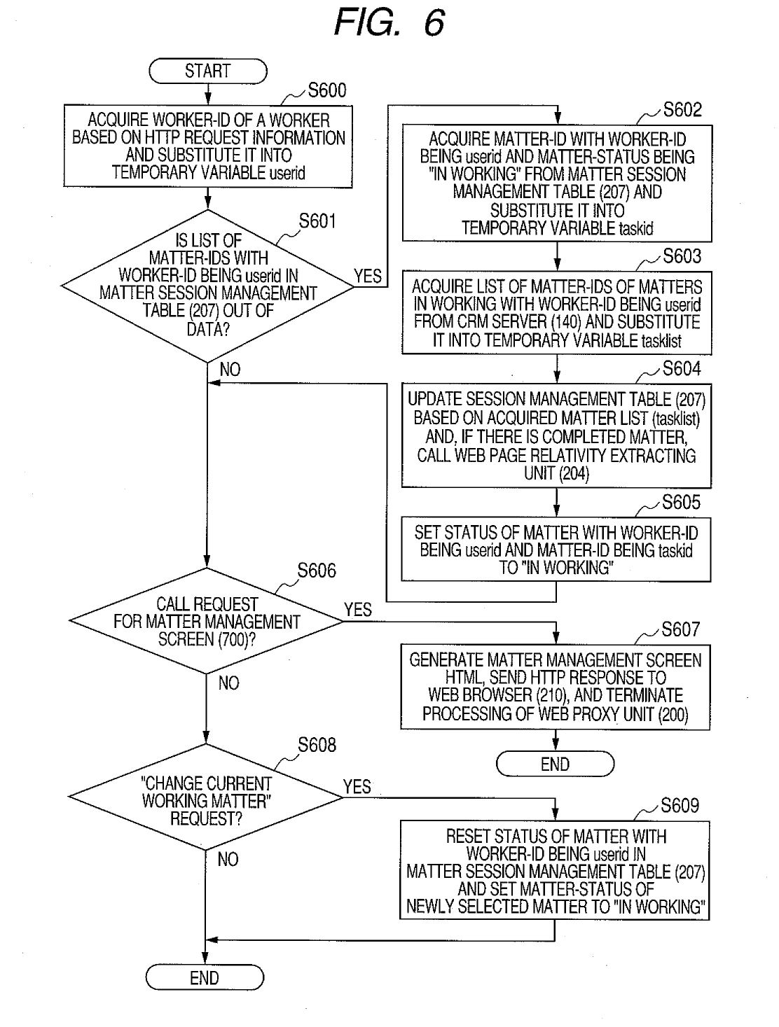

FIG. 6 is a flowchart illustrating processing by the matter session management unit 203. The processing by the matter session management unit 203 is roughly divided into three. First is processing of acquiring matter information from the CRM server (S602 to S605). Second is processing of generating a matter management screen 700 for explicitly accepting a matter to be addressed (S607). Third is processing of accepting a matter selected by a worker using the matter management screen 700 generated by the second processing (S609). Hereafter, description will be given to each processing with reference to FIG. 6.

First, the matter session management unit 203 acquires the worker-id of a worker who is conducting investigation using the web browser 210 based on HTTP request information from the web browser 210 and substitutes it into temporary variable userid (S600). The acquisition of a worker-id can be achieved by, for example, preparing a correspondence table of the IP address of each worker PC 100 and each worker-id. This recommend system may be provided with a user management function, such as HTTP Basic authentication or HTML From authentication, commonly used in web applications. In this case, the worker-id can be acquired from the user management function.

With respect to the matter session management table 207, subsequently, it is determined whether or not a list of matter-ids with the worker-id being userid is up to date as compared with information from the CRM server 140 (S601). This determination can be implemented by utilizing API (Application Program Interface) for external linkage provided by the CRM server 140 or directly referring to the database of the CRM server 140.

When the list of matter-ids is not up to date, the matter information is updated by the processing of Step S602 to Step S605. First, a matter-id with the worker-id being userid and the matter status being “In working” is acquired from the matter session management table 207 and it is substituted into temporary variable matterid (S602). Subsequently, a list of the matter-ids of matters in working with the worker-id being userid is acquired from the CRM server 140 and it is substituted into temporary variable matterlist (S603). As mentioned above, the acquisition of the matter-id list can be achieved by utilizing the API for linkage or referring to the database. The session management table 207 is updated based on the acquired matter list (matterlist) (S604). If there is any completed matter, the web page relativity extracting unit 204 is called. Subsequently, the matter status of a matter with the worker-id being userid and the matter-id being matterid is set to “In working” (S605) and the flow proceeds to Step S606.

After the completion of the above processing block, the matter session management unit determines whether or not the HTTP request is a call request for the matter management screen 700 (S606). When the HTTP request is a call request for the matter management screen 700, it generates matter management screen HTML, sends an HTTP response to the web browser 210, and terminates the processing of the web proxy unit 200 (S607).

After the completion of the above processing block, the matter session management unit determines whether or not the HTTP request is a “change current working matter” request (S608). When the HTTP request is a “matter to be addressed selection” request, the matter session management unit carries out the following processing: it resets the status of a matter with the worker-id being userid in the matter session management table 207 and then sets the matter status of a newly selected matter to “In working” (S609). Here, the selected matter is acquired from the HTTP request.

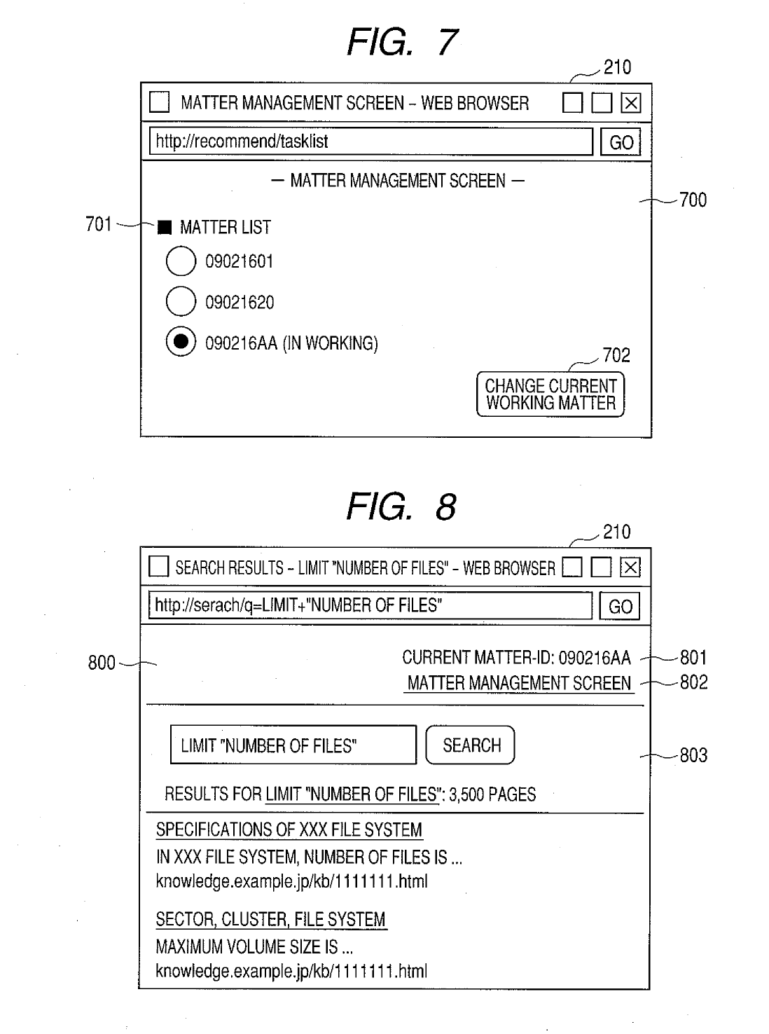

FIG. 7 illustrates an example of the matter management screen. The matter management screen 700 contains at least a list (701) of matters of which the worker has charge and an interface (702) for selecting a matter. The list of matters can be achieved by selecting information on the worker from the matter session management table 207. When the worker starts investigation with respect to another matter, he/she selects a matter to be investigated from the matter list 701 in the matter management screen 700 and presses a matter to be addressed selection button 702. When the matter to be addressed selection button 702 is pressed, the web browser 210 sends an HTTP request containing the selected matter-id to the web proxy unit 200. In accordance with the above-mentioned flowcharts in FIG. 4 and FIG. 6, the matter session management unit 203 proceeds to Step S609 and captures information on matter change.

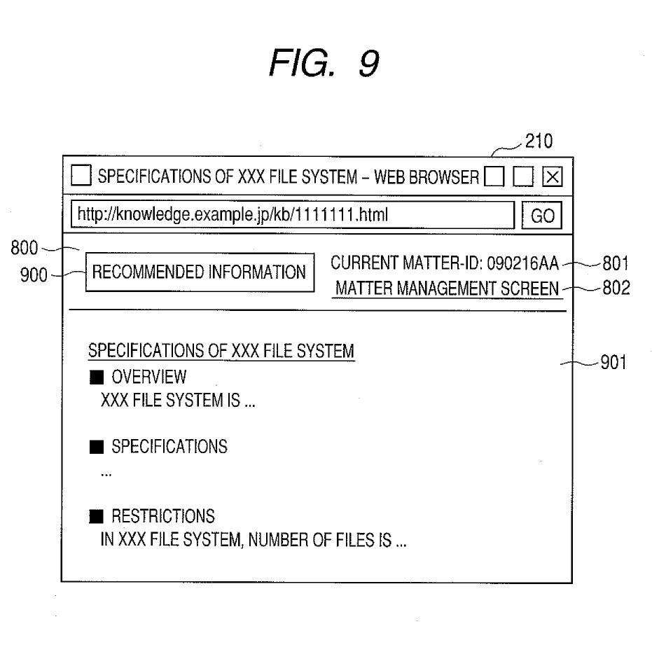

FIG. 8 illustrates an example of a web search screen. A recommendation information display area 800 is added to the ordinary web search screen 802. In the web search screen, the recommendation information display area 800 contains the current matter-id 801 and a link to the matter management screen 700. FIG. 9 illustrates an example of a web page display screen image. The recommendation information display area 800 is added to an ordinary web page 901. In the web page display screen image, the recommendation information display area 800 contains the current matter-id 801, a link to the matter management screen, and recommended information 900. In accordance with the flowcharts in FIG. 4 and FIG. 6, the recommendation information display area 800 is inserted into the HTTP response at Step S407 in FIG. 4.

In the description of this embodiment, cases where the recommendation information display area 800 is embedded in the web search screen 802 or the web page 901 have been taken as examples. However, any displaying unit may be taken as long as the above display items are contained. For example, the recommendation information display area 800 may be displayed as a separate window or may be displayed by separately preparing an add-on program to the web browser.

### <<Web Access Recording Unit>>

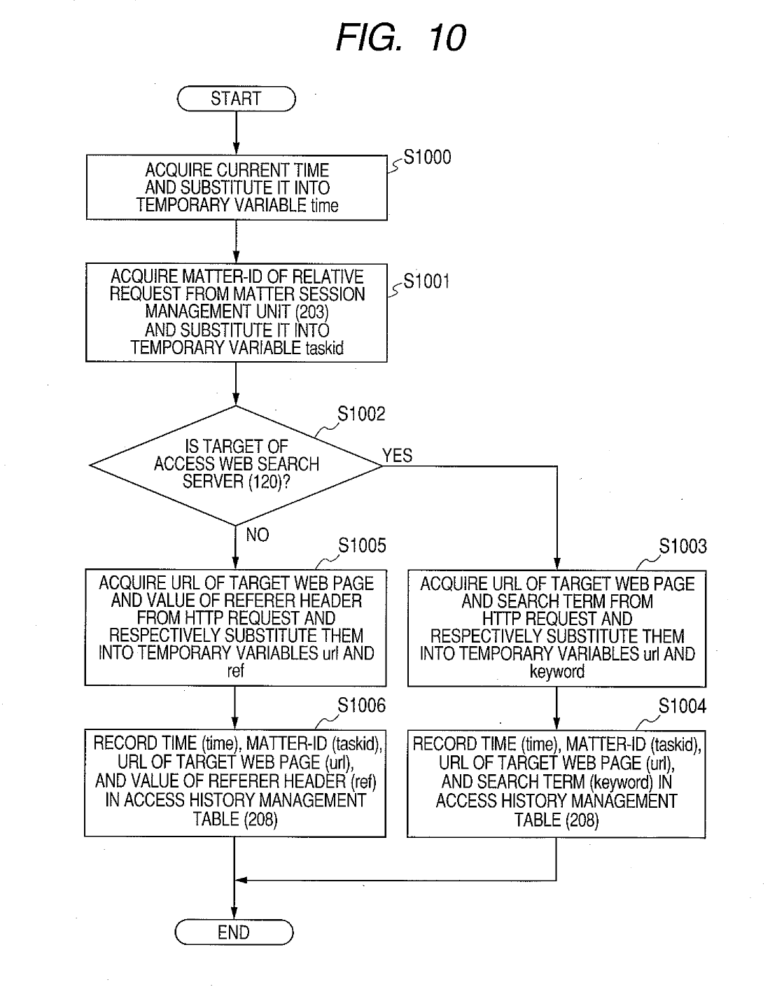

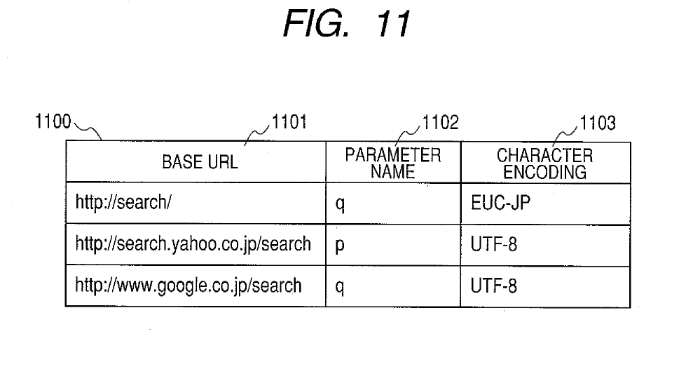

FIG. 10 is a flowchart illustrating processing by the web access recording unit 201. The web access recording unit is called by the web proxy unit 200 and records the histories of web page referencing and web search. First, it acquires the current time and substitutes it into temporary variable time (S1000). Subsequently, it acquires the matter-id from the matter session management unit 203 and substitutes it into temporary variable matterid (S1001). Then it determines whether or not the URL, or the target of access, contained in the HTTP request is for a web search server 120 (S1002). The determination of the target of access is carried out by referring to the search engine definition table 1100 illustrated in FIG. 11. The search engine definition table 1100 defines the base URL 1101 of each web search server, the parameter name 1102 of each search term, and the character encoding 1103 of each search term. When the URL in the HTTP request is contained in the base URLs 1101, the access is determined to be access to a web search server. The search engine definition table 1100 may be prepared in any format, such as database and file, as long as the web an access recording unit 201 can refer thereto. Or, a logic for determination may be embedded into the program beforehand.

When the target of access is a web search server 120, the web access recording unit acquires the URL of the target web page and a search term from the HTTP request and respectively substitutes them into temporary variables url and keyword (S1003). The search term is extracted from a request parameter or POST data based on the definition of the parameter name 1102 and the character encoding 1103 in the search engine definition table 1100. Subsequently, the web access recording unit records the time (time), matter-id (matterid), URL of the target web page (url), and search term (keyword) in the access history management table 208 (S1004).

When the target of access is not a web search server 120, that is, it is a web content server 130, the web access recording unit carries out the following processing: it acquires the URL of the target web page and the value of the Referer header from the HTTP request and respectively substitutes them into temporary variables url and ref (S1005). Subsequently, it records the time (time), matter-id (matterid), URL of the target web page (url), and the value of the Referer header (ref) in the access history management table 208 (S1006).

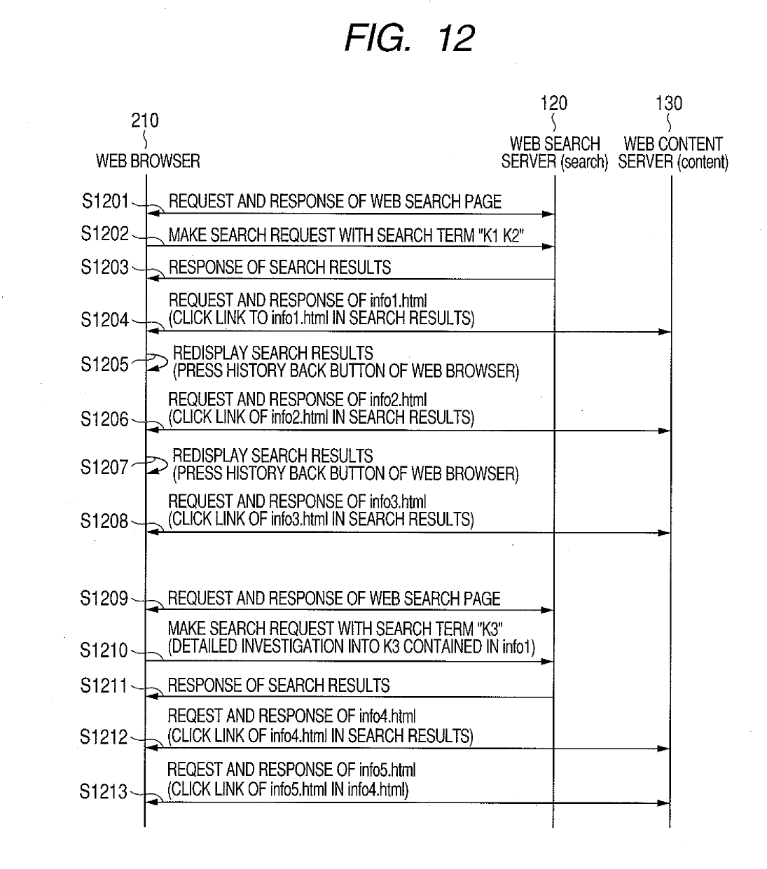

FIG. 12 is a sequence diagram illustrating an example of a series of processes of web search and web page referencing in matter investigation.

In this example, the worker conducts investigation from the viewpoint of a search term “K1 K2” first (Step S1201 to Step S1208). The worker repeats referencing a search result and a web page and refers to three web pages. Specifically, the following occurs: the operation begins with the display of a list of search results; info1.html is displayed (S1204); a list of search results is displayed again (S1205); info2.html is displayed (S1206); a list of search results is displayed again (S1207); and info3.html is displayed (S1208). Cases where the history back button of the web browser 210 is pressed to redisplay a list of search results are based on the assumption that the cache of the web browser 210 is utilized and a search request is not resent to the web search server 120.

Subsequently, the worker conducts detailed investigation with respect to a keyword K3 contained in the web page info1 (Step S1209 to Step S1213). The worker conducts a search with the search term “K3” (Step S1210), refers to the web page info4.html (S1212), and then clicks a link contained in info4.html to refer to the web page info5.html.

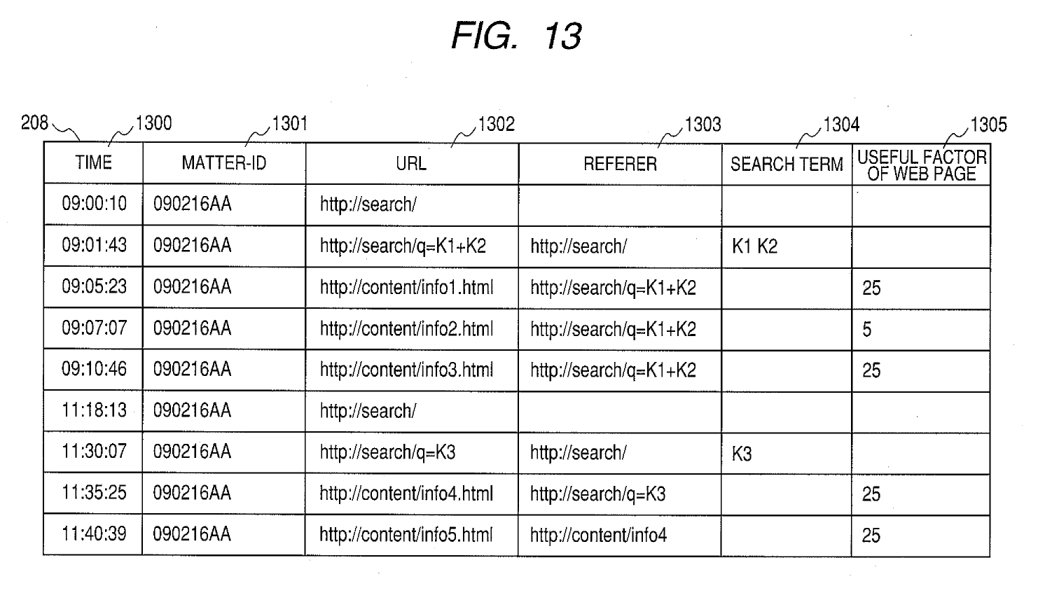

FIG. 13 illustrates the access history management table 208 obtained as the result of the series of processes of web search and web page referencing illustrated in FIG. 12. The access history management table 208 is composed of time 1300, matter-id 1301, access URL 1302, Referer 1303, search term 1304, and useful web page factor 1305. The useful web page factor 1305 is calculated by the useful web page capture module 209 and the useful web page factor calculating unit 214 described below.

### <<Useful Web Page Capture Module and Useful Web Page Factor Calculating Unit>>

The useful web page capture module 209 runs on the web browser 210 or the OS of the worker PC 100 of each worker and captures the status of referencing web pages utilizing the web browser 210. The useful web page factor calculating unit 214 that runs on the CPU 112 of the recommendation server 110 computes the serviceability of a web page based on the status of referencing the web page captured by the useful web page capture module 209.

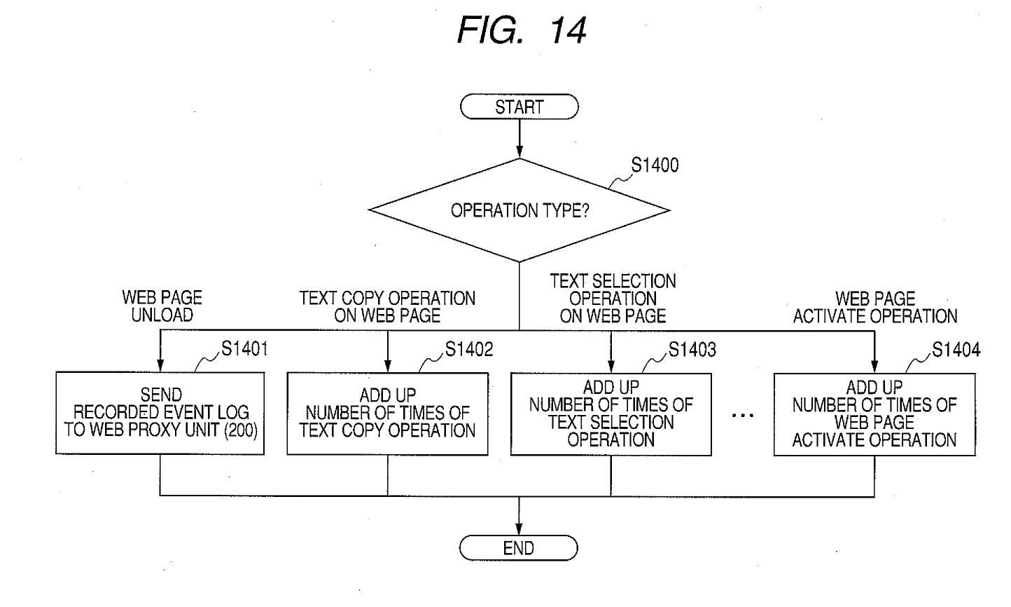

FIG. 14 roughly illustrates the flow of processing by the useful web page capture module 209. The useful web page capture module 209 operates as an event handler in the web browser 210 or OS (for example, the Windows (registered trademark) OS from Microsoft Corporation). This event handler carries out varied processing according to the type of each operation (S1400). When a copying operation with respect to text in a web page displayed on the web browser 210 is detected, the event handler adds up the number of times of text copy operation (S1402). When a selection operation with respect to text in a web page displayed on the web browser 210 is detected, it adds up the number of times of text selection operation (S1403). When a web page becomes active, it adds up the number of times when it becomes active (S1404).

When a web page unloading event is detected, the event handler sends an event log acquired as the result thereof to the web proxy unit 200 (S1401). At Step S402, the web proxy unit 200 determines that it is a call for an internal function and at Step S408, the web proxy unit calls the useful web page factor calculating unit 214.

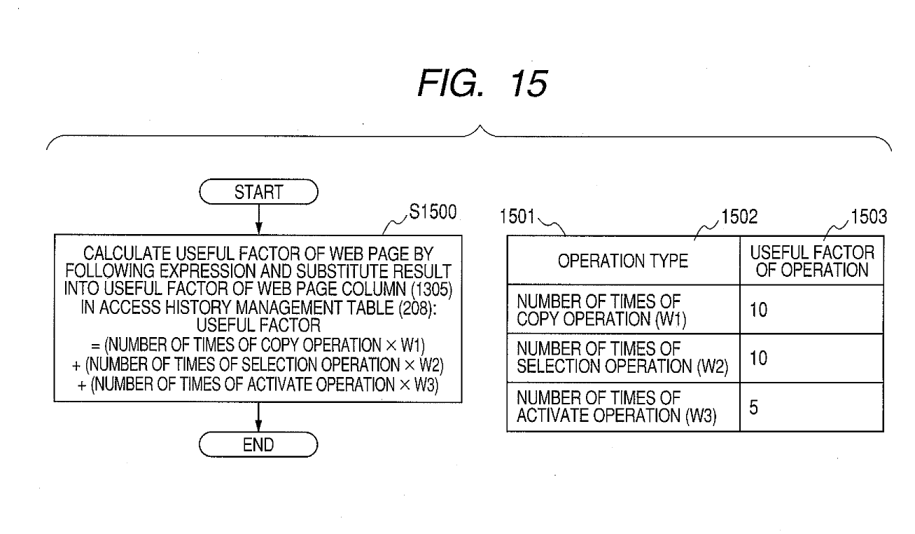

FIG. 15 is a flowchart illustrating processing by the useful web page factor calculating unit 214. The serviceability of a web page is calculated by taking the following measure with respect to each operation with the web browser 210 by the worker captured by the useful web page capture module 209: weighting is carried out using the operation serviceability coefficients indicated in a table 1501 (S1500).

This example is based on the assumption that with respect to info1.html info3.html, info4.html, and info5.html, the worker copied a useful portion and pasted it to a Notepad application. Therefore, the following data is obtained with respect to each of the four web pages: the number of times of copy operation is 1; the number of times of selection operation is 1; and the number of times of activate operation is 1. As a result, the serviceability is 25. With respect to info2.html, the number of times of activate operation is 1 and its serviceability is 5.

With respect to the calculation of serviceability in FIG. 14 and FIG. 15, the status of operation of the web browser may be simply incorporated. Such status of operation includes web page browsing time, the amount of movement of a mouse on a web page, the amount of scroll, web browser window duplicating operation, and the like. The serviceability of a web page may be determined by referring to information in any other system. Some examples will be taken. When it is detected that a web sticky note (annotation tool) has been stuck to a web page, there is a high possibility that information captured in the process of investigation has been inputted. Therefore, the page may be determined to be high in serviceability. A state in which a web sticky note is sticking to a web page can be detected by linking up with the management interface of the annotation tool. Similarly, when it is detected that a web page has been added to a bookmark, there is a high possibility that the worker has determined this web page to be variable information. Therefore, the page may be determined to be high in serviceability. Whether or not a web page has been bookmarked can be detected by liking up with the management interface of the bookmark tool.

When the URL of a web page or text in the web page is copied to the CRM server 140 recording the process of processing, it can be determined to be high in serviceability. Whether or not information is written in the CRM server 140 can be detected by carrying out character string matching between the URL and text of a web page and the contents of the relative matter in the CRM server 140.

Linkage with other systems may be implemented by linking up with an operation log acquisition tool (PC operation efficiency analysis system BM1 (http://www.hitachi-system.co.jp/bm1/) from Hitachi Systems & Services, Ltd. or the like).

### <<Web Page Relativity Extracting Unit>>

The web page relativity extracting unit 204 is called by the processing of Step S604 when the processing of the matter related to an inquiry is completed. First the web page relativity extracting unit carries out the following processing as preprocessing: it generates information on the process of accessing web pages based on history information recorded in the access history management table 208 and temporarily records it in the access process management table 205. Subsequently, it extracts the relativity between web pages based on the access process management table 205 with respect to the web pages and records it in the web page relativity table 206.

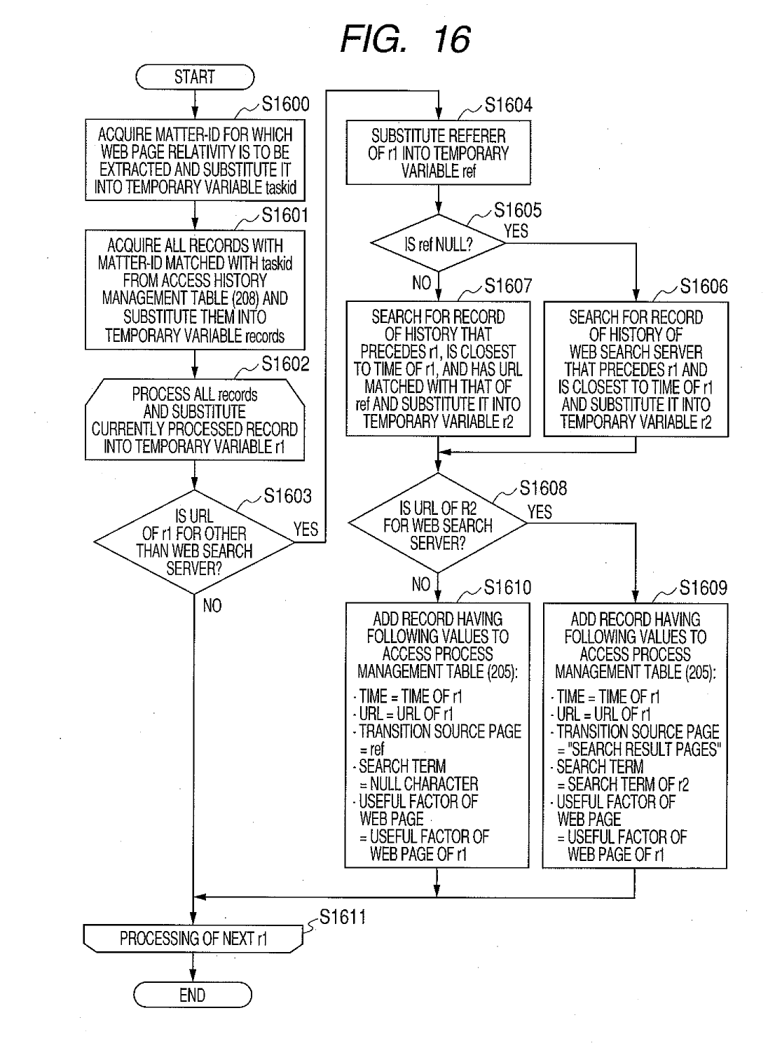

FIG. 16 is a flowchart for generating the access process management table 205 that stores information on the process of accessing web pages. The information on the process of accessing web pages is defined as (1) the web page as the web page transition source web page and (2) when the web page as the transition source page is a search result, the search term. Especially, with respect to this search term, the following can be said: it is a keyword best representing the features of web pages in a matter in working. The process of accessing is basically generated based on Referer information of web pages. Hereafter, detailed description will be given with reference to FIG. 16.

First, the matter-id of a matter for which web page relativity is to be extracted is acquired and it is substituted into temporary variable matterid (S1600). Subsequently, all the records with the matter-id matched with the value of matterid are acquired from the access history management table 208 and substituted into temporary variable records (S1601). With respect to the acquired records, the following processing is carried out (S1602). At this time, the currently processed record is substituted into temporary variable r1.

When the URL of record r1 is not for a web search server, the following processing is carried out (S1603). The Referer of record r1 is substituted into temporary variable ref (S1604). Subsequently, the flow of processing is branched depending on the presence or absence of ref (S1605). When ref is null, a record of history of a web search server that precedes r1 and is closest to the time of r1 is searched for and it is substituted into temporary variable r2 (S1606). When ref is not null, a record of history that precedes r1, is closest to the time of r1, and has URL matched with that of ref is searched for and it is substituted into temporary variable r2 (S1607).

Subsequently, the flow of processing is branched depending on whether or not the URL of record r2 is for a web search server (S1608). When the URL of record r2 is for a web search server, a record comprised of the following values is added to the access process management table 205 (S1609): time=the time of r1; URL=the URL of r1; transition source page=“search result page”; search term=the search term of r2; and useful web page factor=the useful web page factor of r1. When the URL of record r2 is not for a web search server, a record comprised of the following values is added to the access process management table 205 (S1610): time=the time of r1; URL=the URL of r1; transition source page=ref; search term=null character; and useful web page factor=the useful web page factor of r1.

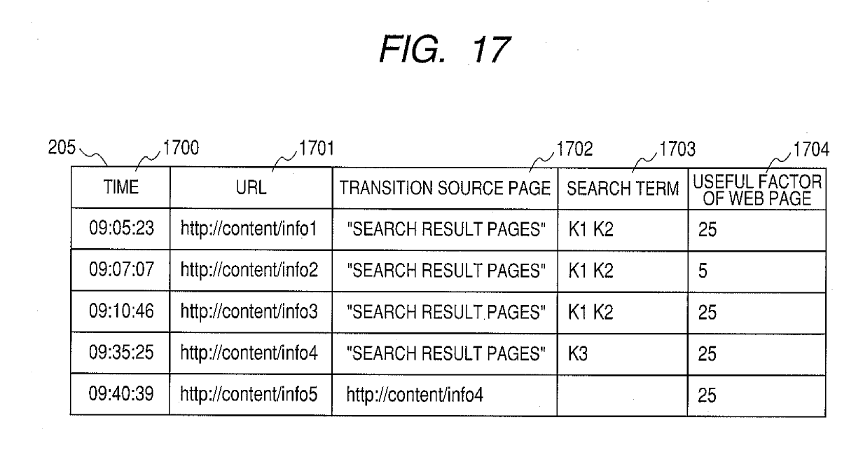

FIG. 17 illustrates the contents of the access process management table 205 obtained after the above processing is carried out with respect to the access history management table 208 illustrated in FIG. 13. The access process management table 205 is composed of the time of referencing 1700, URL 1701, transition source page 1702, search term 1703, and useful web page factor 1704 with respect to each referenced web page. As mentioned above, the search term 1703 is a keyword conductive to the relative web page.

In the flowchart in FIG. 16, multiple records are generated when there are multiple accesses to an identical URL. Instead, they may be summarized as a single record. They may be summarized into the record at the earliest time of accessing or may be summarized into the record at the latest time of accessing.

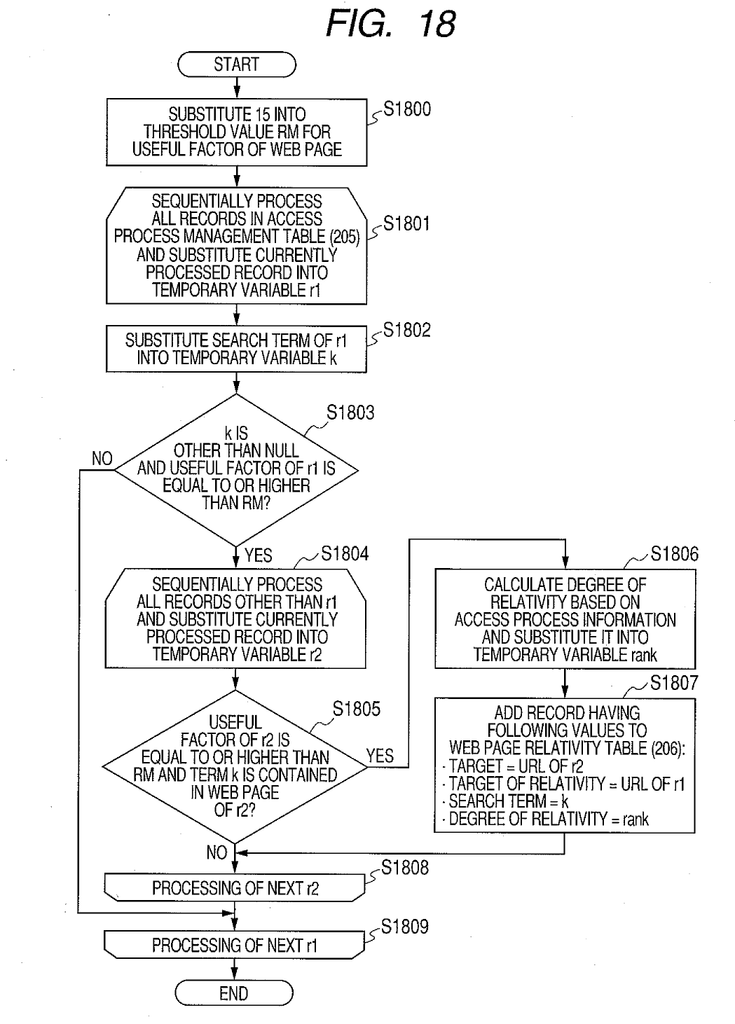

Subsequently, web page relativity is extracted based on information on the process of accessing web pages stored in the access process management table 205. FIG. 18 is a flowchart illustrating processing by the web page relativity extracting unit 204. When relativity is extracted, web pages whose serviceability is not less than a certain value are taken as targets of relativity extraction. This makes it possible to reduce noise in web page recommendation. In this embodiment, this threshold value is set to 15 at Step S1800. However, this value can be adjusted by the relativity degree adjusting unit described later.

First, the web page relativity extracting unit substitutes 15 into the threshold value RM for useful web page factor (S1800). This RM indicates the threshold value for the serviceability of web pages as targets of relativity extraction. Subsequently, it sequentially carries out the following processing with respect to all the records in the access process management table 205 (S1801). At this time, the currently processed record is substituted into temporary variable r1. Then the web page relativity extracting unit substitutes the search term of r1 into temporary variable k (S1802). Subsequently, when k is other than null and the serviceability of r1 is not less than RM, it carries out the processing of Step S1804 to Step S1808; and in the other cases, it proceeds to the processing of the next record (S1803).

When k is other than null and the serviceability of r1 is not less than RM, the web page relativity extracting unit sequentially carries out the processing with respect to all the records other than r1 (S1804). Here, it substitutes the currently processed record into temporary variable r2. Subsequently, when the serviceability of r2 is not less than RM and keyword k is contained in the web page corresponding to the URL of r2, it is assumed that there is relativity between the web pages of r1 and r2 and it proceeds to Step S1806. When the above condition is not met, the web page relativity extracting unit proceeds to the processing of the next record (S1805).

Whether or not a keyword is contained in a web page can be detected by acquiring this web page through HTTP communication and conducting a full-text search with respect to the web page. Or, it can be detected by generating an index of a keyword when the process of accessing web pages is recorded and searching for this index. When a search term is comprised of multiple keywords, the following measure may be taken: search processing is carried out with respect to each keyword and when at least one keyword is found, the search term is determined to be contained in the web page. Or, the following measure may be taken: search processing is carried out with a search formula obtained by combining multiple keywords; and when the search formula is matched, that is, when all the keywords are found, they are determined to be contained in the web page. The above search processing need not be carried out based on keyword agreement and may be implemented by searching for a similar keyword. Similar keyword searching can be achieved by combining a synonym dictionary and the like.

When the serviceability of r2 is not less than RM and keyword k is contained in the web page corresponding to the URL of r2, the following processing is carried out (S1806): a relativity degree is calculated based on process of accessing information and is substituted into temporary variable rank. The details of relativity degree calculation will be described after the description of this flowchart. Subsequently, the web page relativity extracting unit adds a record comprised of the following values to the web page relativity table 206 (S1807) origin of relativity=the URL of r1; target of relativity=the URL of r2; search term=k; and relativity degree=rank. This makes it possible to extract the relativity between the web pages.

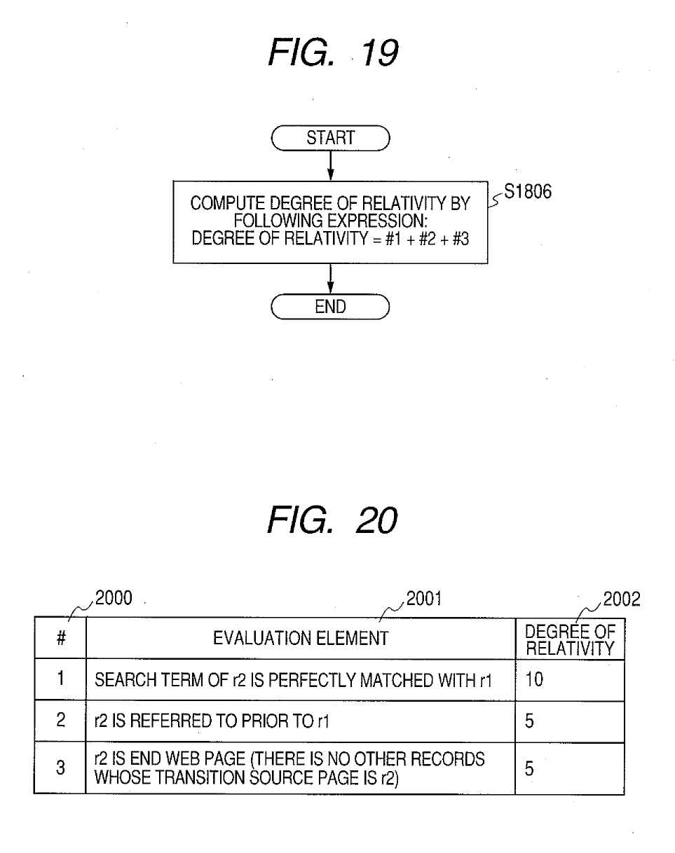

FIG. 19 is a flowchart illustrating the details of the relativity degree calculation described in relation to the processing of Step 1806. The relativity degree is calculated based on the process of referencing r1 and r2. When it can be assumed that the search term of r1 is detailed investigation pertaining to information in the page of r2, the relativity degree is set to a higher value.

FIG. 20 illustrates examples of the evaluation element and relativity degree. #1 is equivalent to a case where a search term that enables arrival at a web page is perfectly matched. In this case, it can be assumed that the relativity between web pages is high. As a variation of #1, a relativity degree may be calculated based on keyword similarity, not perfect matching of keyword. Similar keyword searching can be achieved by combining a synonym dictionary and the like. In case of #2, r2 is referred to prior to r1. That is, it can be considered that the contents contained in r2 (search term for r1) are investigated in detail in r1. In this case, it can be assumed that the relativity degree between r1 and r2 is high. In case of #3, it can be considered that the end web page is a page at which investigation is aborted once to separately conduct detailed investigation into a search term of r1. In this case, it can be assumed that the relativity degree between r1 and r2 is high. With respect to #, a relativity degree is calculated based on positional relation during the process of accessing web pages. Aside from increasing the relativity degree of the end web page, a relativity degree may be increased based on the positional relation to the end web page, for example, it is increased with increase in proximity to the end web page.

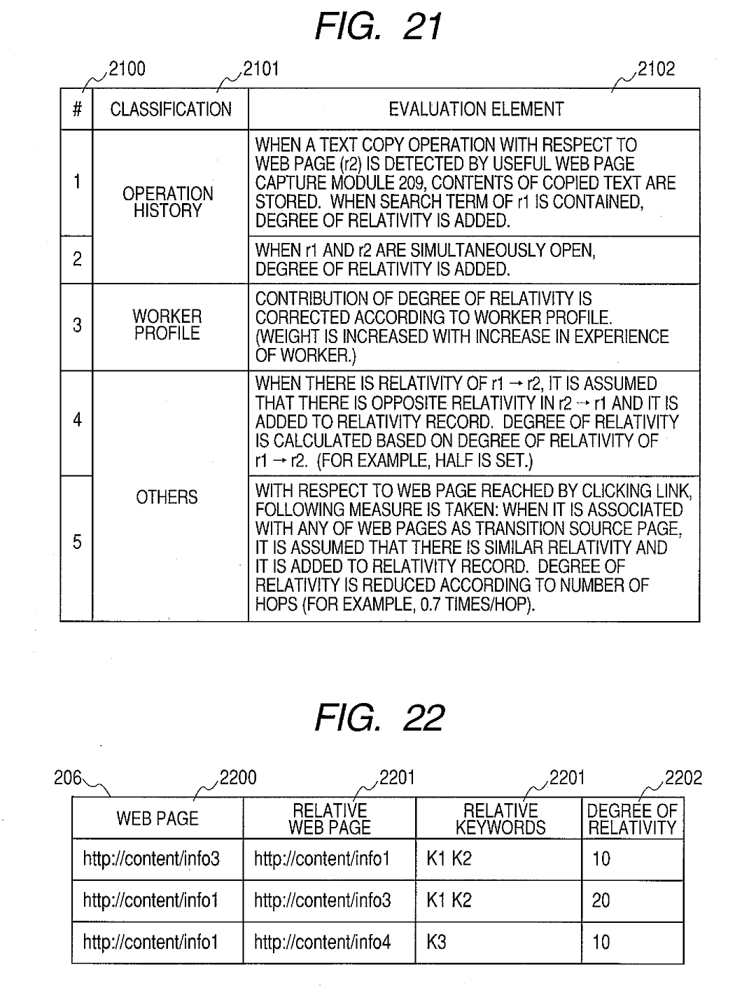

Aside from the foregoing, the viewpoints listed in FIG. 21 are possible. For example, the relativity degree may be added with attention focused on the history of operation as described below. (1) When a text copy event with respect to a web page (r2) is detected by the useful web page capture module 209, the contents of the copied text are stored. When a search term of r1 is contained, the relativity degree is added. (2) When r1 and r2 are simultaneously open, the relativity degree is added. In the cases of (1) and (2), a relativity degree is evaluated based on the status of investigation with the web browser by the user at the time of web page referencing. Further, the relativity degree may be added with attention focused on the profile of each worker as described below. (3) The contribution of a relativity degree is corrected according to the profile of each worker. (For example, the weight is increased with increase in the experience of each worker.) Further, the following measure may be taken: (4) When there is the relation of r1→r2, it is assumed that there is opposite relation in r2→r1 and this opposite relation is added as a record to the web page relativity table 206. A relativity degree can be calculated based on the relativity degree of r1→2. (For example, half is set.) With respect to a web page reached by clicking a link, the following measure may be taken: (5) When it is related to any of web pages as the transition source page, it is assumed that there is the similar relation and a record is added to the web page relativity table 206. The relativity degree can be calculated by reducing a value according to the number of hops or taking any other like measure (for example, 0.7 times/hop).

FIG. 22 is a table illustrating the web page relativity table 206 generated as the result of the above processing. This example incorporates only the relativity degree calculation illustrated in FIG. 20.

### <<Relativity Degree Adjusting Unit>>

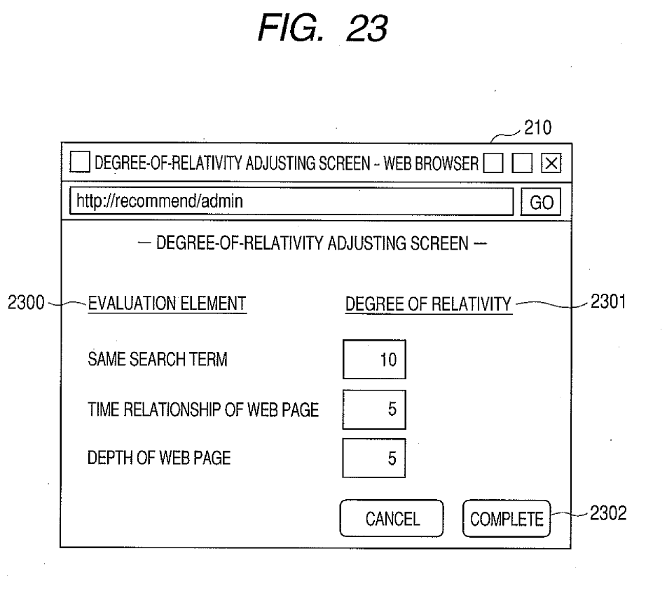

FIG. 23 illustrates an example of the interface of the relativity degree adjusting unit. The evaluation element and the relativity degree for the relativity degree calculation illustrated in FIG. 20 and FIG. 21 differ in on what the evaluation element is focused depending on conducted operation and the set of addressed web pages. When the relativity degree of each evaluation element is made variable using this interface, it is possible to apply this embodiment to a wide variety of environments. When the relativity degree adjusting unit 215 is called by the web browser 210 through the web proxy unit 200, it generates the adjustment interface illustrated in FIG. 23. This screen is composed of a list of the evaluation element 2300 and the relativity degree 2301. When the value of a relativity degree is corrected and then the Complete button is pressed, the relativity degree adjusting unit 215 is called through the web proxy unit 200. The relativity degree adjusting unit 215 acquires the variation in relativity degree and reflects it in the relativity degree calculation portion (FIG. 18) of the web page relativity extracting unit 204.

In the above description, an interface for relativity degree adjustment by a web interface has been taken as an example. However, any interface, such as configuration file correction and RDB updating, can be used as long as it can change the setting of the relativity degree 2301 of the evaluation element 2300.

With respect to relativity degree adjustment, a single value may be set for a system or may be set with respect to each user. Or, it may be set on a group-by-group basis by managing multiple users in groups.

### <<Web Page Recommendation Unit>>

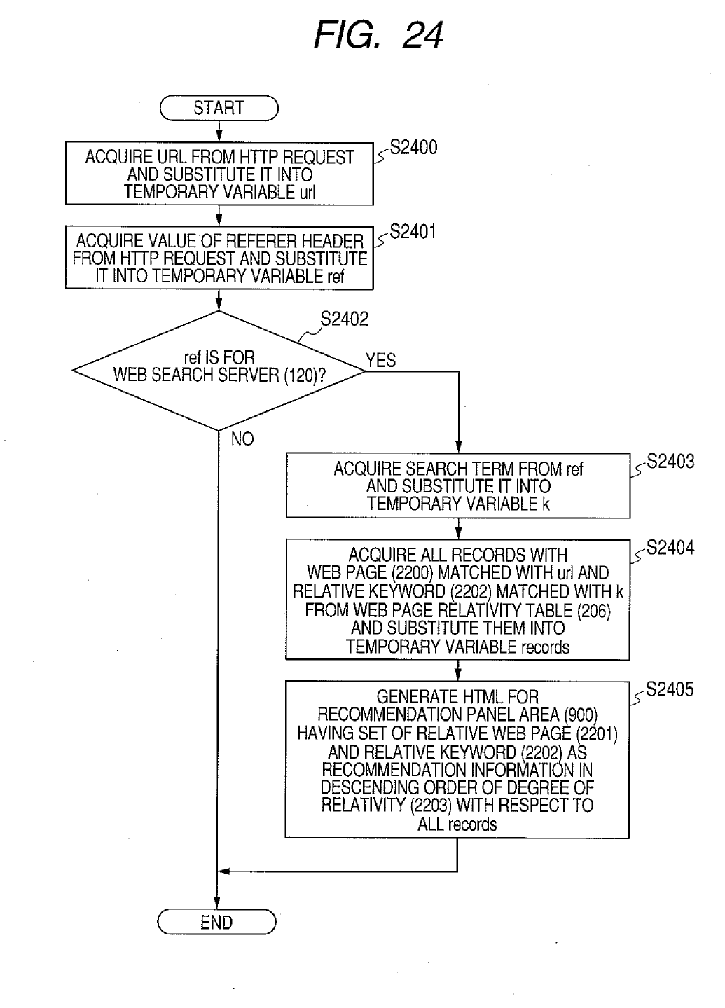

FIG. 24 is a flowchart illustrating processing by the web page recommendation unit 202. The web page recommendation unit 202 refers to the web page relativity table 206 extracted by the web page relativity extracting unit 204 and recommends an associated web page during web page referencing. As described with reference to FIG. 4, the web page recommendation unit 202 is called in extension of processing (S406) by the web proxy unit 200.

First, the web page recommendation unit acquires URL from an HTTP request and substitutes it into temporary variable url (S2400). Subsequently, it acquires the value of the Referer header from the HTTP request and substitutes it into temporary variable ref (S2401). Then it determines whether or not ref is a request to a web search server 120 (S2402). When ref is a request to a web search server, it carries out the processing of Step S2403 to Step S2405. First, the web page recommendation unit acquires a search term from ref and substitutes it into temporary variable k (S2403). Subsequently, it acquires all the records with the web page 2200 matched with url and the relative keyword 2202 matched with k from the web page relativity table 206 and substitutes them into temporary variable records (S2404). Then it generates HTML for a recommend panel 900 having a set of the relative web page 2201 and the relative keyword 2202 as recommendation information in descending order of relativity degree 2203 with respect to all the records (S2405).

The thus generated HTML for the recommend panel 900 is embedded in an HTTP response at Step S407 in FIG. 4 and is sent to the web browser 210 by the web proxy unit 200.

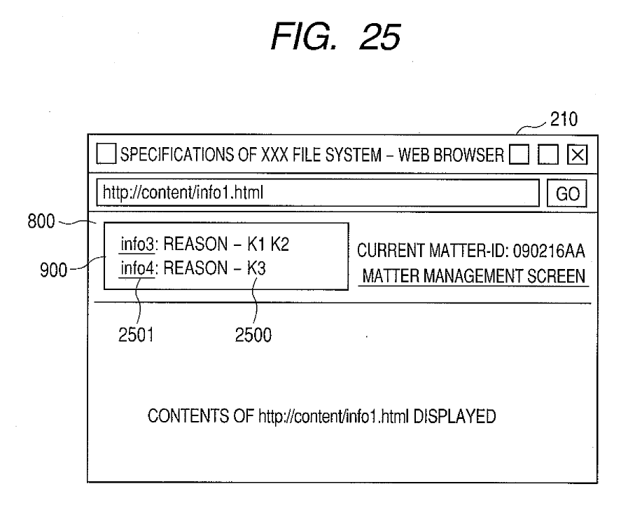

FIG. 25 illustrates an example of recommendation information generated by the web page recommendation unit 202. This example illustrates the result of recommendation obtained when the following operation is performed: at a web search server, a search is conducted with a keyword “K1 K2” and http://content/info1.html is clicked in a list of the search results to refer to info1.html. As illustrated in this example, info3.html and info4.html are recommended as web pages related to info1.html. At the time of recommendation, a pertinent web page is not simply recommended but a search term used as information on which relativity is based is simultaneously displayed as a viewpoint of recommendation. This enhances the usefulness of recommendation information. A worker can predict beforehand whether or not recommendation information is highly relative to the matter he/she is presently addressing to some degree by referring to viewpoint information (search term).

The description of the above processing is based on the assumption of perfect matching of keyword. Instead, the similar processing may be carried out also with respect to a similar keyword by determining the degree of similarity of keywords using a dictionary or the like.

To capture the range of a matter, in the above embodiment, information on the start and end of the matter is acquired from a worker using a web interface. Instead, an interface, such as add-on software to a web browser or a dedicated client application, other than web may be used to capture the start and end. Or, information from any other system, such as CRM, may be utilized to capture the range of a matter. In place of strictly managing matters, investigation within a unit time (for example, a day) may be considered as investigation into one matter. Investigation into a matter may be determined in conjunction with the start and termination of a browser. The end and termination of a browser can be captured by separately installing software for monitoring the operation of PC in each worker PC.

Above is the description of an example of processing in the first embodiment.

### Second Embodiment

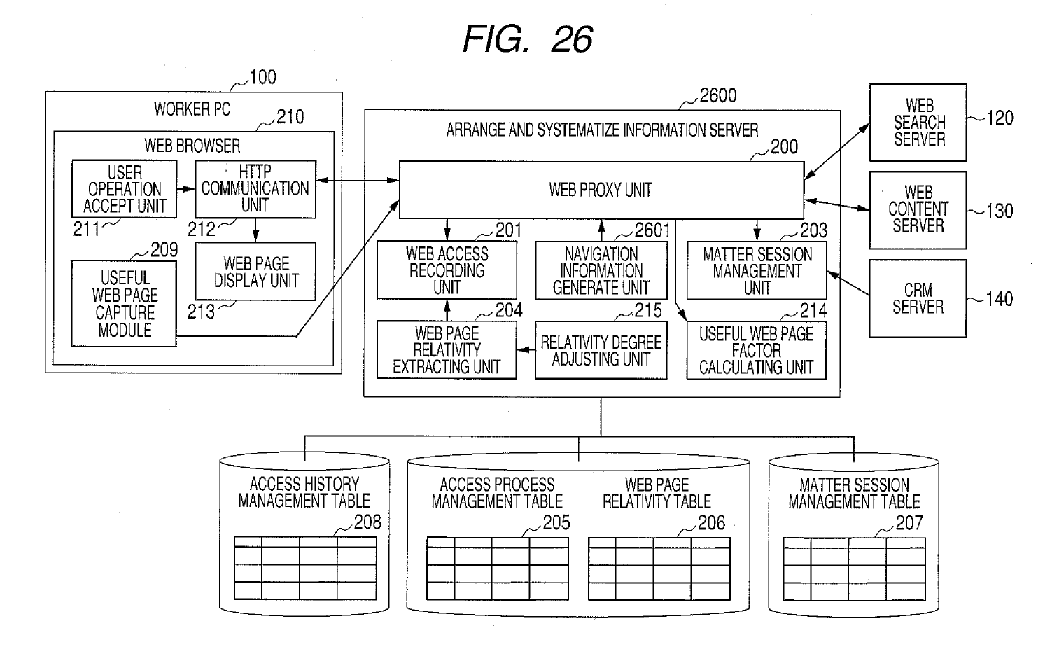

In the second embodiment, the invention is applied to assembling and organization of information present inside and outside a business organization. FIG. 26 is a block diagram illustrating the functional elements of programs that run on an arrange and systematize information server 2600. Similarly with the recommendation server 110 in the first embodiment, the arrange and systematize information server 2600 extracts web page relativity. This arrange and systematize information server 2600 is composed of the same computer system as the recommendation server 110 illustrated in FIG. 1 and is comprised of CPU, a memory, I/F, and an external storage any of which is not shown in the drawing. A navigation information generate unit 2601 is used in place of the web page recommendation unit 202 among the programs executed by the CPU.

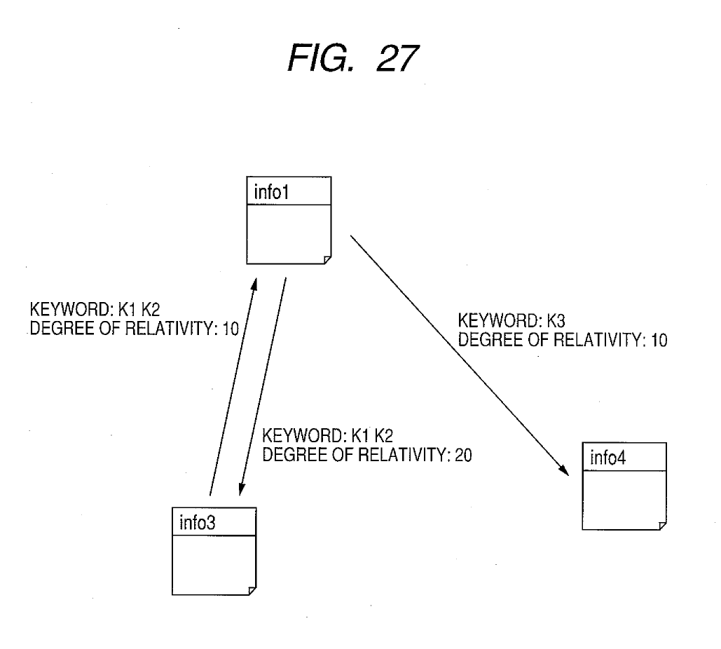

In this embodiment, extracted web page relativity has the structure of effective graph. For example, the web page relativity table 206 illustrated in FIG. 22 can be considered as the effective graph illustrated in FIG. 27. This form of effective graph is utilized to virtually assemble and organize information present inside and outside a business organization and a function for information navigation is thereby provided. The effective graph for information navigation is generated by the navigation information generate unit 2601.

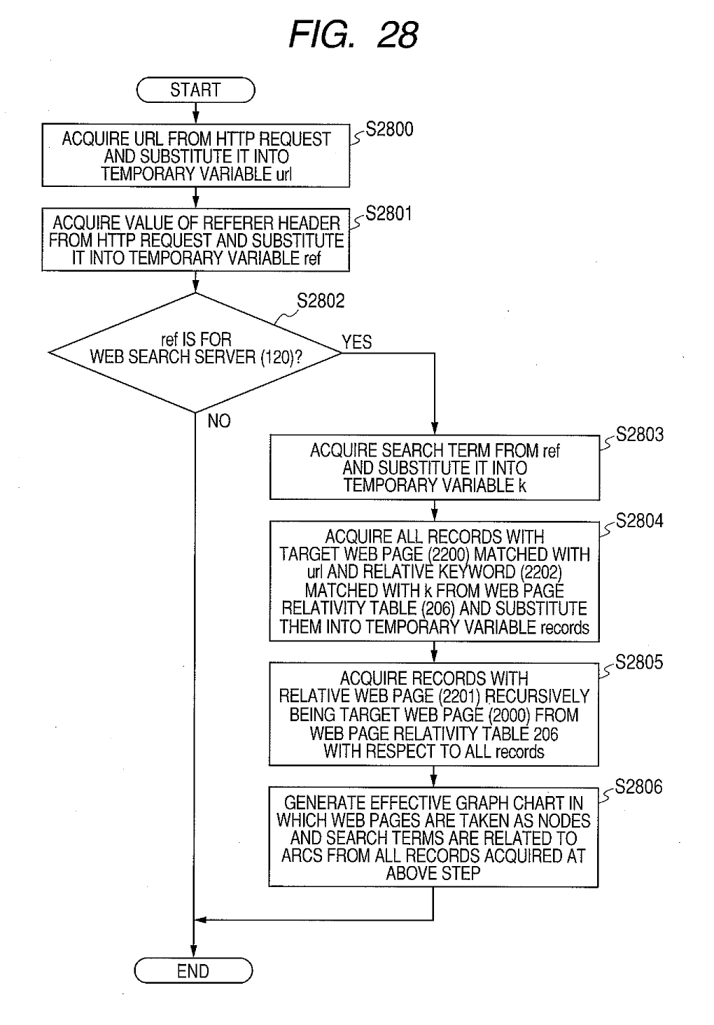

FIG. 28 is a flowchart for the navigation information generate unit 2601 to generate a view for content navigation. This processing is obtained by expanding the flow of processing by the web page recommendation unit 202 illustrated in FIG. 24.

The navigation information generate unit 2601 refers to the web page relativity table 206 extracted by the web page relativity extracting unit 204. Then it displays web page navigation information with a referenced pertinent web page taken as the starting point during web page referencing. As in the first embodiment, the navigation information generate unit 2601 is called in extension of processing (S406) by the web proxy unit 200.

First, the navigation information generate unit acquires URL from an HTTP request and substitutes it into temporary variable url (S2800). Subsequently, it acquires the value of the Referer header from the HTTP request and substitutes it into temporary variable ref (S2801). Then it determines whether or not ref is a request to a web search server 120 (S2802). When ref is a request to a web search server, it carries out the processing of Step S2803 to Step S2806. First, the navigation information generate unit acquires a search term from ref and substitutes it into temporary variable k (S2803). Subsequently, it acquires all the records with the web page 2200 matched with url and the relative keyword 2202 matched with k from the web page relativity table 206 and substitutes them into temporary variable records (S2804). Then it acquires records with the relative web page 2201 recursively being the web page 2000 from the web page relativity table 206 with respect to all the records (S2805). Thereafter, it generates an effective graph chart in which web pages are taken as nodes and search terms are related to arcs from all the records acquired at Step S2805 (S2806).

The thus generated effective graph chart is embedded in an HTTP response and sent to the web browser 210 by the web proxy unit as in the first embodiment.

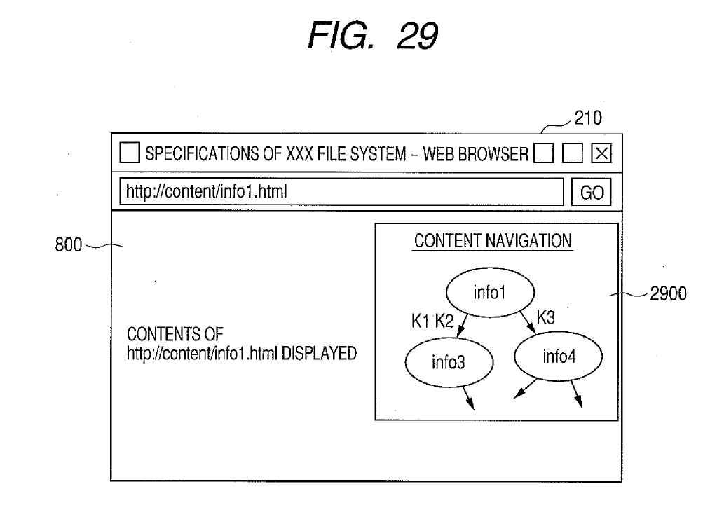

FIG. 29 illustrates an example of content navigation information generated by the navigation information generate unit 2601. This example illustrates the result of content navigation information obtained when the following operation is performed: at a web search server, a search is conducted with a keyword “K1 K2” and http://content/info1.html is clicked in a list of the search results to refer to info1.html. As illustrated in this example, it is possible to present content navigation information by an effective graph of web pages with info1.html taken as the starting point. This navigation information makes it possible to systematically overlook the entire contents, reduce wistful information search, and more efficiently conduct a search for effective information.

The invention described in detail up to this point is useful in implementing the following in operation of referring to web pages and conducting investigation: the implicit relativity between referenced web pages is extracted and a web page is recommended or navigation information for web page referencing is provided based on the extracted relativity.

What is claimed is:

1. An extraction method for web page relativity in which when one or more web pages are referred to with respect to some case and the case is investigated, the relativity between the web pages is extracted by a processing unit,
wherein the processing unit executes:
a procedure for recording a search term for a web search server and the process of accessing web pages;
a detection procedure for detecting whether or not a first web page referred to within the range of the recorded web pages is reached by transition from a search result of the web search server and the search term is contained in a second web page referred to within the range of the recorded web pages by search with a search term; and
a relativity extraction procedure for, when the search term is contained in the second web page, assuming that there is relativity between the first and second web pages and evaluating a relativity degree indicating the intensity of relativity between the first and second web pages based on the process of accessing the first and second web pages.

2. The extraction method for web page relativity according to claim 1,
wherein the processing unit further executes a serviceability evaluation procedure for capturing the action of a user who determines a referenced web page to be useful to evaluate the serviceability of the web page, and
wherein the relativity extraction procedure extracts the relativity degree based on the serviceability evaluated.

3. The extraction method for web page relativity according to claim 2,
wherein the relativity extraction procedure evaluates the relativity degree based on the status of operation with a web browser by a user when the user refers to the web page high in the serviceability.

4. The extraction method for web page relativity according to claim 1,
wherein the relativity extraction procedure evaluates the relativity degree based on positional relation between a series of web pages during a process of accessing.

5. The extraction method for web page relativity according to claim 1,
wherein the relativity extraction procedure evaluates the relativity degree based on the relation of referencing time between web pages.

6. The extraction method for web page relativity according to claim 1,
wherein the processing unit further comprises a procedure for managing the identification and profile of a user, and
wherein the relativity extraction procedure evaluates the relativity degree by the profile of the user.

7. The extraction method for web page relativity according to claim 1,
wherein the processing unit further comprises a procedure for capturing the range of a case, and
wherein the relativity extraction procedure extracts relativity with respect to between web pages within the captured range of the case.

8. The extraction method for web page relativity according to claim 3,
wherein the processing unit evaluates the relativity degree in accordance with the weighting of an evaluation item for the relativity degree set by a user.

9. The extraction method for web page relativity according to claim 1,
wherein the processing unit recommends a web page based on the relativity degree evaluated by the relativity extraction procedure.

10. The extraction method for web page relativity according to claim 9,
wherein when the processing unit recommends a web page, the processing unit recommends a search term for the web page as viewpoint information of the recommendation together with the web page.

11. An extraction device for web page relativity which, in operation of referring to one or more web pages with respect to some case and investigating the case, extracts relativity between the web pages and comprises a processing unit and a storage unit,
wherein the processing unit comprises:
a web access recording unit that records a search term for a web search server and the process of accessing web pages; and
a web page relativity extracting unit that detects whether or not a first web page referred to within the range of the recorded web pages is reached by transition from a search result of the web search server and the search term is contained in a second web page referred to within the range of the recorded web pages by search with a search term and, when the search term is contained, assumes that there is relativity between the first and second web pages and evaluates a relativity degree indicating the intensity of relativity between the first and second web pages based on the process of accessing between the first web page and the second web page, and
wherein the storage unit has a web page relativity table composed of the first and second web pages, the search term that functioned as a key to relativity, and the relativity degree.

12. The relativity extraction device according to claim 11,
wherein the processing unit further comprises a useful web page factor calculating unit that quantitatively evaluates the action of a user who determines a referenced web page to be useful to obtain the serviceability of the web page, and
wherein the web page relativity extracting unit extracts the relativity degree based on the serviceability of the web page.

13. The relativity extraction device according to claim 11,
wherein the processing unit further comprises a relativity degree adjusting unit for a user to set the weighting of an evaluation item for the relativity degree.

14. A computer readable medium storing an extraction program causing a computer to execute a process for web page relativity for, in operation of referring to one or more web pages with respect to some case and investigating the case, extracting relativity between the web pages, executed by the processing unit of a web page relativity extraction device including a processing unit and a storage unit, the process comprising:
recording a search term for a web search server and the process of accessing web pages;
detecting whether or not a first web page referred to within the range of the recorded web pages is reached by transition from a search result of the web search server and the search term is contained in a second web page referred to within the range of the recorded web pages by search with a search term; and
when the search term is contained in the second web page, assuming that there is relativity between the first and second web pages and evaluating a relativity degree indicating the intensity of relativity between the first and second web pages based on the process of accessing the first and second web pages.

15. The computer readable medium storing an extraction program causing a computer to execute the process for web page relativity according to claim 14, the process further comprising:
when a web page is recommended based on the relativity, recommending the search term for the recommended web page as viewpoint information of the recommendation together with the web page.
